(19) United States
(12) Patent Application Publication
(10) Pub. No.: US 2026/0094461 A1
(43) Pub. Date: Apr. 2, 2026

(54) ATTESTABLE DEEPFAKE DETECTION AND/OR PREVENTION

(71) Applicant: GDM Holding LLC, Mountain View, CA (US)

(72) Inventor: Christopher Schneider, Edmonds, WA (US)

(21) Appl. No.: 19/338,315

(22) Filed: Sep. 24, 2025

Related U.S. Application Data
(60) Provisional application No. 63/700,994, filed on Sep. 30, 2024.

(51) Int. Cl. G06V 20/00; G06F 9/455

(52) U.S. Cl. CPC G06V 20/95; G06F 9/45558

(57) ABSTRACT

Implementations are described herein for detecting deepfakes in digital media while preserving the privacy of the source computing device. In various implementations, sensor fingerprints and/or security tokens that signal software-introduced alterations, e.g., introduced by hardware abstraction layers (HALs) or virtual machines (VMs) may be utilized to detect such deepfakes. These signals may be used, separately and/or in combination, for various purposes, such as flagging digital content to a user as being a deepfake, preventing or blocking receipt and/or playback of digital content deemed to be a deepfake, allowing an end user to disable aspect(s) (e.g., layers) of digital content that are determined to be synthetic, etc.

### BACKGROUND

Deepfakes are synthetic digital content in which audible and/or visual features of recorded (or “ground truth” or “sensor captured”) digital content are altered using machine learning and/or artificial intelligence. The features are often altered to change the appearance, sound, behavior, and/or identity of a person that appeared in the original recorded digital content. As one example, a film scene may be altered to swap the originally recorded actor with a different actor's appearance. Deepfakes have been used maliciously for a variety of purposes, such as creating synthetic audio and/or video of public figures engaging in behavior that reflects poorly on them in real life. Deepfakes have also been used in real-time video conferencing applications, e.g., to work around authentication and authorization controls and to gain access to various protected resources.

### SUMMARY

Implementations are described herein for detecting deepfakes using one or more signals. More particularly, but not exclusively, implementations are described herein for detecting, in digital content such as digital videos, digital audio, etc., one or both of sensor fingerprints and/or security tokens that signal software-introduced alterations. These security tokens may be introduced by components capable of attesting on behalf of environments, such as virtual machines (VMs) and/or hardware abstraction layers (HALs). In various implementations, these signals may be used, alone and/or in combination, for various purposes, such as flagging digital content to a user as being from a source computing device that is different than a purported source of the digital content, flagging the digital content as a deepfake, preventing or blocking receipt and/or playback of digital content deemed to be a deepfake, allowing an end user to disable aspect(s) (e.g., layers) of digital content that are determined to be synthetic, etc.

In various implementations, digital content such as a video or video stream that is purported to originate from a particular source, such as a particular person's smartphone and/or a sensor thereof, may be analyzed to extract various signals. These signals may be usable, alone or in combination, to determine whether the video/video stream is truly from the purported source and/or includes software-introduced alterations that suggest the digital content may be a deepfake. For example, one signal may be usable to verify (or refute) whether the digital content was generated by a purported source of the digital content, which may be a particular computing device and/or one or more sensors of the particular computing device. Another signal may be usable to identify whether software-introduced alterations have been incorporated into the digital content.

As one example, vision sensors typically have noisy characteristics, such as errors that produce minute, consistent variations in output that are often not detectable by humans but are detectable by computing devices, that make them unique. These noisy characteristics may be introduced during manufacturing or during subsequent use of the sensor. For example, a digital camera chip may be manufactured with flaw(s) that cause one or more pixels to generate anomalous data values, e.g., values that diverge from expected ranges (e.g., ranges of neighboring pixels). These anomalous values may or may not be visible to a person viewing a video generated using the digital camera chip, but may be detectable using any combination of hardware and software and likely will be relatively unique to that digital camera. As another example, a lens of a digital camera may become scratched over time, and these scratches may introduce artifacts into digital images and/or videos that are unique to that digital camera.

In various implementations, a sensor “fingerprint” may be identified, extracted, formulated, etc., that represents one or more noisy characteristics of a sensor, particularly a vision sensor such as a digital camera. This sensor fingerprint may be shared, e.g., between the “source” computing device having the sensor in question and other computing device(s) that are provided digital content (e.g., images, video) by the source computing device. For example, during a trusted and synchronous communication session (e.g., due to other trust verification means being employed, trusted third parties/signatures, the devices being co-present, etc.) between a source computing device and a receiving computing device, the receiving computing device may analyze digital content provided by the source computing device to extract a sensor fingerprint for the source computing device and/or one or more of its sensors. The receiving computing device may then store this sensor fingerprint in memory. Subsequently, the receiving computing device may compare the stored reference sensor fingerprint to a new sensor fingerprint extracted from new digital content to determine whether the new digital content truly originated from the source computing device.

In some implementations, sensor fingerprints may be stored by trusted third parties so that they are accessible to verify digital content at times other than during synchronous communication. For example, in some (but not all) implementations, the source computing device may extract a sensor fingerprint from digital content it creates locally, and store data indicative of that sensor fingerprint on one or more remote computing devices, e.g., as part of an immutable ledger that is accessible subsequently to authenticate the source computing device. In other implementations, another computing device, in trusted communication with the source computing device, may extract the sensor fingerprint and store them on the immutable ledger. However the sensor fingerprint is extracted, once it is stored at the immutable ledger, other computing devices may then be able to compare sensor fingerprints extracted from subsequent digital content purported to be shared by the source computing device to the previously shared sensor fingerprint, e.g., to verify or refute the source.

In some implementations, sensor fingerprints may be accessible via means other than an immutable ledger. For example, individual contacts of a user's contact list may be associated with reference sensor fingerprints extracted from digital content provided by the respective contact. As the respective contact upgrades their computing devices and/or sensors, or as the respective contact's computing devices and/or sensors degrade over time and/or are damaged, the user's contact list may likewise be updated to include new reference sensor fingerprints that accurately reflect the current state of the respective contact's computing devices and/or sensors.

If the sensor fingerprints match or are at least sufficiently similar, the other computing device may determine that the digital content genuinely originated from the source computing device. If the sensor fingerprints don't match, on the other hand, the other computing device may determine that either the digital content did not originate at the source computing device, or at the very least, the source computing device's sensor fingerprint needs updating (e.g., to reflect wear and tear over time, replacement of the sensor, etc.).

In addition to or instead of determining that the digital content originates from the purported source computing device, in various implementations, the digital content may be examined to determine whether any software-introduced alterations were made to the digital content. The presence of software-introduced alterations may be probative of the digital content being a deepfake. For example, in some implementations, the digital content may be examined to detect security token(s) that may have been incorporated into the digital content, e.g., via a virtual machine and/or HAL of the source computing device.

In some implementations, the digital content may include multiple layers, such as video and audio layer(s), as well as one or more layers that include software-introduced alterations, such as a blurred background, one or more filters that alter an appearance and/or sound of people depicted in the video, etc. In various implementations, a source computing device that creates the digital content, e.g., by capturing audio and/or visual data using one or more sensors, may bond, merge, interleave, or otherwise combine various layers together, e.g., into a single inseparable layer. As noted previously, the source computing device may also incorporate security token(s) into one or more of the layers, e.g., via the virtual machine and/or HAL.

In some implementations, these security tokens may be selectively incorporated into layer(s) so that those layer(s) become immutable, e.g., at a receiving device. By contrast, other layer(s) may remain mutable (e.g., capable of being disabled). For example, in some implementations, a source computing device may bond audio and video layers together into a combined immutable layer. The source device's virtual machine and/or HAL may then incorporate security token(s) into that immutable layer to indicate that the immutable layer's contents have not been altered downstream of the virtual machine and/or HAL, e.g., by a client application operating in user space of the source computing device. Meanwhile, other layers that were altered downstream of the virtual machine and/or HAL, such as layers that include filters altering an appearance of someone depicted in a video, may not include security tokens and therefore may be identifiable as including software-introduced alteration(s).

Not all software-introduced alterations are necessarily discouraged. For example, a blurred background may be beneficial for preserving the privacy of a user and/or their surroundings. Accordingly, in some implementations, the layer of the digital content corresponding to this blurred background may be made immutable, e.g., by being modified by the virtual machine and/or HAL to include one or more security tokens. For example, in some implementations, the blurred background layer may be included with (e.g., bonded, merged, interleaved, etc.) the audio and/or video layers to form the combined immutable layer mentioned previously. This combined immutable layer and/or its constituent sublayers may be processed by the virtual machine and/or HAL to incorporate security token(s). Other layers that include software-introduced alterations, such as filters that alter the user's appearance, may remain mutable, e.g., so that they can be disabled at a receiving computing device.

While many examples described herein relate to determining whether digital videos depicting a person's face constitute deepfakes, this is not meant to be limiting. Techniques described herein may be applicable to any sensor-based biometric authentication framework, such as retinal scans, fingerprint scans, voice recognition, etc. For example, a smart phone's touchscreen may include a portion that is configured to operate as a fingerprint scanner. This portion of the touchscreen may include various noisy characteristics introduced during manufacturing and/or during use of the smartphone (e.g., most smart phone screens accumulate scratches over time). These noisy characteristics can be used to extract a sensor fingerprint for the fingerprint sensor portion of the touchscreen. This sensor fingerprint may be used as described herein to verify whether subsequent fingerprint scans truly originated from a purported source fingerprint scanner.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1a schematically depicts an example environment in which disclosed techniques may be employed, in accordance with various implementations.

FIG. 1b depicts an example of how various components depicted in FIG. 1a may cooperate to carry out selected aspects of the present disclosure.

FIG. 2 depicts a general overview of an example of preventing a deepfake.

FIG. 3 depicts an example of how the techniques of independent claim 1 may be implemented into the graphical user interface (GUI) of a smartphone.

FIG. 4 depicts an example of how various techniques described herein may be implemented into a specific environment.

FIG. 5 depicts an example method for practicing selected aspects of the present disclosure.

FIG. 6 depicts an example method for practicing selected aspects of the present disclosure.

FIG. 7 schematically depicts an example architecture of a computer system.

### DETAILED DESCRIPTION

Implementations described herein relate to verifying a particular computing device as the purported source of digital content (e.g., video, audio, and streaming content) and/or identifying whether the digital content was altered by means of software. This verification and identification may be achieved using various signals, such as sensor fingerprint(s) that uniquely identify sensor(s), and/or security token(s), sometimes introduced by a component such as a virtual machine (VM) and/or machine hardware abstraction layer (HAL), that indicate whether digital content has been altered by software. In various implementations, these signals may be used, separately and/or in combination, for various purposes, such as flagging digital content to a user as being a deepfake, preventing or blocking receipt and/or playback of digital content deemed to be a deepfake, allowing an end user to disable aspect(s) (e.g., layers) of digital content that are determined to be synthetic, etc.

Techniques described herein provide for a variety of technical advantages. Deepfakes allow users to simulate the identities, behaviors, and mannerisms of others through leveraging machine learning to create synthetic digital content. Such simulation can erode the effectiveness of authentication and authorization controls and processes that rely on various biometrics such as facial recognition, retinal pattern matching, voice matching, etc. This in turn can lead to various digital concerns such as unauthorized access to bank accounts, sophisticated phishing campaigns, etc.

Techniques described herein enable the detection of deepfakes to, among other things, preserve privacy and/or reduce deepfake-based infiltration of sensitive electronic resources. Techniques described herein may be used to determine whether digital content received at a client computing device (e.g. a cell phone, a wearable device, a laptop, a desktop computer, etc.), which purportedly originated from sensor(s) (e.g., camera, microphone) of a source computing device, constitutes a deepfake. Techniques described herein may also be used to take appropriate remedial action, such as notifying the user of the client computing device, preventing or ceasing playback of the digital content, denying or blocking access to an electronic resource that uses biometric authentication, etc.

The client computing device may utilize any of a number of various signals to make these determinations, including, but not limited to sensor fingerprint(s) and embedded security token(s). Such a sensor fingerprint may, for example, embody a noisy characteristic of the sensor or sensors of the source computing device. Such a noisy characteristic may include one or both of manufacturing defects, such as faulty pixels in a camera which produce pixel values that do not conform to an expected range (e.g., consistently out of range of neighbor pixels), and defects which result from post-manufacturing activities, such as scratches to the camera lens of a cell phone or water damage to the microphone of a wearable device. Such noisy characteristics may be detected, e.g., at the client computing device when establishing a trusted relationship with the source computing device. Once detected, these noisy characteristics may be utilized to formulate a unique fingerprint of the sensor(s) of the source computing device. This unique fingerprint can then be leveraged by any receiving client device to verify the source computing device as the actual source of digital content.

In combination or separately, various implementations described herein may utilize a security token to identify or flag digital content which has been altered by means of software. In some implementations, the digital content may include multiple layers, such as video and audio layer(s), as well as one or more layers that include software-introduced alterations, such as a blurred background, one or more filters that alter an appearance and/or sound of people depicted in the video, etc. In such implementations, security tokens can be incorporated, e.g., via the VM/HAL, into various layer(s) so that the individual layer(s) cannot be further altered without detection.

Such signals, once embedded in digital content, may be detected and used by a receiving client computing device to verify a purported source device and/or identify digital content which has been altered. Techniques described herein may be used during live streaming of digital content, which may be referred to herein as “synchronous communication,” and/or sometime after the digital content's creation. As an example of live streaming, a first computing device receiving a live streaming video purportedly transmitted by a second computing device may analyze the streaming video, e.g., in real time, to detect sensor fingerprint(s) and/or security tokens and take appropriate action if the streaming video appears to be a deepfake. Techniques described herein are also applicable outside of live streaming. For example, in some implementations, the various signal(s) described herein-particularly the sensor fingerprints—may be stored in an immutable distributed ledger. Anytime thereafter, any receiving client device may compare signal(s) extracted from digital content to the signal(s) previously stored in the distributed ledger, e.g., to verify or refute the source.

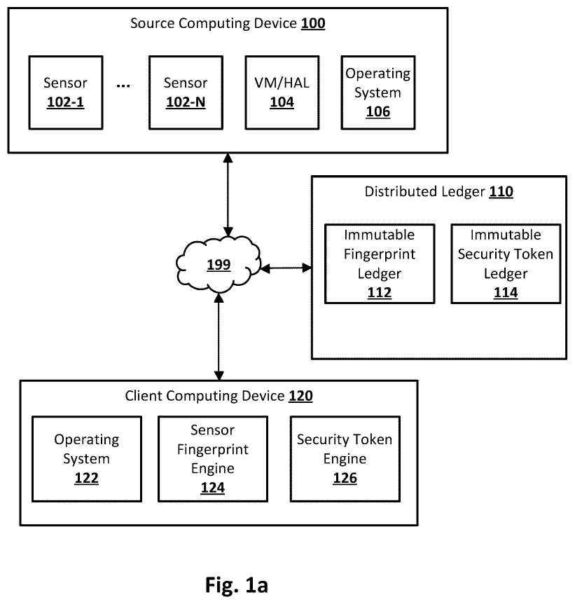

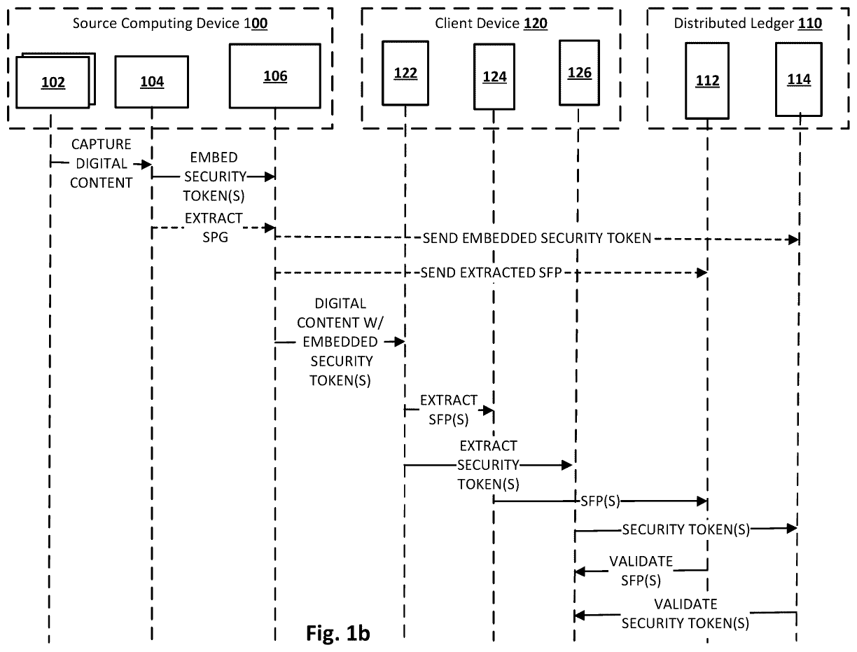

FIG. 1a depicts an environment in which the above-described techniques may be performed. Such an environment may include a source computing device 100, a client computing device 120, and an optional distributed ledger 110, all three communicatively coupled via one or more networks 199 (e.g., one or more local area networks and/or wide area networks, including the Internet). In such an environment, the source computing device 100 may be the purported source of the digital content being verified.

Computing devices described herein such as client computing device 120 and source computing device 100 may take various forms, including but not limited to a cell phone, a tablet computer, a laptop, a desktop computer, a wearable device, a standalone speaker (with or without an onboard camera), etc. In various implementations, the source computing device 100 may have one or more sensor(s) 102-1 . . . 102-N such as a microphone, a camera, etc. The one or more sensor(s) 102-1 . . . 102-N may be used to capture the digital content that is subsequently evaluated using techniques described herein.

The source computing device 100 may also have one or more attestable environments, such as VM and/or HAL 104, which can be utilized to embed or otherwise incorporate various security token(s) into one or more layers of the captured digital content. These security token(s) may signal whether the digital content was altered by software, e.g., to alter the appearance of a person or object depicted in a digital video. The digital content may then be sent to the source computing device's 100 operating system 106 where further actions may be taken. One such possible action is the transmission of the digital content to client computing device 120.

In some implementations, the optional distributed ledger 110 may be used to store sensor fingerprints and/or security tokens so that they can be used subsequently, e.g., outside of synchronous communication (e.g., live video conferencing), to evaluate digital content as potential deepfakes. In some implementations, when source computing device 100 creates digital content, it may extract noisy sensor characteristic(s) detected in the digital content. Additionally or alternatively, another computing device in a trusted relationship with source computing device 100 may extract these noisy sensor characteristics. In either case, these noisy sensor characteristics may be formulated as sensor fingerprint(s) and sent to the distributed ledger 110, e.g., alone and/or with security token(s). The distributed ledger 110 may then store these sensor fingerprints in an immutable manner. These sensor fingerprint(s) may then be accessible by other computing devices (e.g. via a network 199) so that other computing devices can utilize the sensor fingerprint(s) to authenticate the source computing device 100 as the actual source of digital content.

The client computing device 120 may be a recipient of the digital content being verified. Such a client device may have an operating system 122 capable of receiving the digital content, as well as a sensor fingerprint engine 124 and a security token engine 126. Upon receipt of the digital content, the operating system may utilize the various engine(s) to evaluate the digital content. In many examples described herein, client computing device 120 is described as a computing device operated by a user. However, this is not meant to be limiting. In various implementations, client computing device 120 may be part of a server or cloud infrastructure that hosts resources that are protected by biometric security measures such as voice, facial, fingerprint, and/or retinal recognition etc. In such a scenario, client computing device 120 may be configured to practice selected aspects of the present disclosure to evaluate incoming biometric signals, such as digital audio and/or digital video, fingerprint scans, retinal scans, etc., to detect deepfakes. If a particular incoming biometric signal is determined to be a deepfake, client computing device 120 may deny access to the resources that are protected by the biometric security measures.

The sensor fingerprint engine 124 may be configured to extract sensor fingerprint(s) from the digital content and compare those sensor fingerprint(s) to reference sensor fingerprint(s) known to be associated with the source computing device 100. These reference sensor fingerprints may be stored locally at the client computing device 120, e.g., in instances where the client computing device 120 is able to establish baseline, trusted reference sensor fingerprint(s) with the source computing device 100 during a trusted communication session (e.g., video conference, telephone call, etc.). Additionally or alternatively, the reference sensor fingerprints may be stored at an immutable ledger 110, e.g., as part of an immutable fingerprint ledger 112.

The security token engine 126 may be configured to evaluate security token(s) or other indications incorporated with, embedded into, or otherwise included with digital content. These security tokens may be usable as attestations that data generated within a particular environment (e.g., by a virtual machine, behind the HAL, etc.) was or was not altered using software, e.g., to include filters or other alterations that might transform the appearance of a person depicted in the digital content.

FIG. 1b depicts an example of cooperation between the various components depicted in FIG. 1a in order to carry out selected aspects of the above describe techniques. In FIG. 1b, time runs down the page. Starting at top left, the sensor(s) 102-1 . . . 102-N of the source computing device 100 may capture digital content. Such digital content may include but is not limited to visual media and/or auditory media. In various implementations, the VM and/or HAL may embed or otherwise incorporate security token(s) into layer(s) of the digital content. These tokens may make various representations and/or attestations, such as that the digital content recorded by the sensor(s) 102 was or was not altered by software.

As indicated by the dashed arrows, in some (but not all) implementations, a component of the source computing device such as the VM and/or HAL 104 may evaluate the recorded digital content to extract a sensor fingerprint (“SFP” in FIG. 1b). This might occur where a trusted third party is involved with the process and/or collecting sensor fingerprints for storage in an immutable fingerprint ledger 112. In some such implementations, the operating system 106 may send the sensor fingerprint and the embedded security token to an immutable fingerprint ledger 112 and immutable security token ledger 114, respectively, to be stored for later use by other computing devices to authenticate the source computing device 100.

The source computing device's 100 operating system 106 may then send the digital content which includes one or more embedded security tokens to the client device's 120 operating system 122. The client device's 120 operating system 122 may then extract the embedded security token(s) and send them to the security token engine 126. Meanwhile, the sensor fingerprint engine 124 may analyze the digital content to extract a sensor fingerprint.

In some implementations, and as shown in FIG. 1b, the sensor fingerprint engine 124 may utilize the immutable fingerprint ledger 112 to validate the received sensor fingerprint. In other implementations, the sensor fingerprint engine 124 may use a locally-stored sensor fingerprint—e.g., previously extracted from digital content known to originate at source computing device 100—as a reference sensor fingerprint for validation. Additionally, in some implementations, including that depicted in FIG. 1b, the security token engine 126 may validate the security token(s) with the security token immutable ledger 114, although this is not required in all cases.

If the client device 120 is unable to validate the received sensor fingerprint, the client device 120 may flag that the source computing device 100 may not be the purported source computing device. Likewise, if the client device 120 is unable to validate the received security token, the client device 120 may flag that the digital content has been altered by means of software.

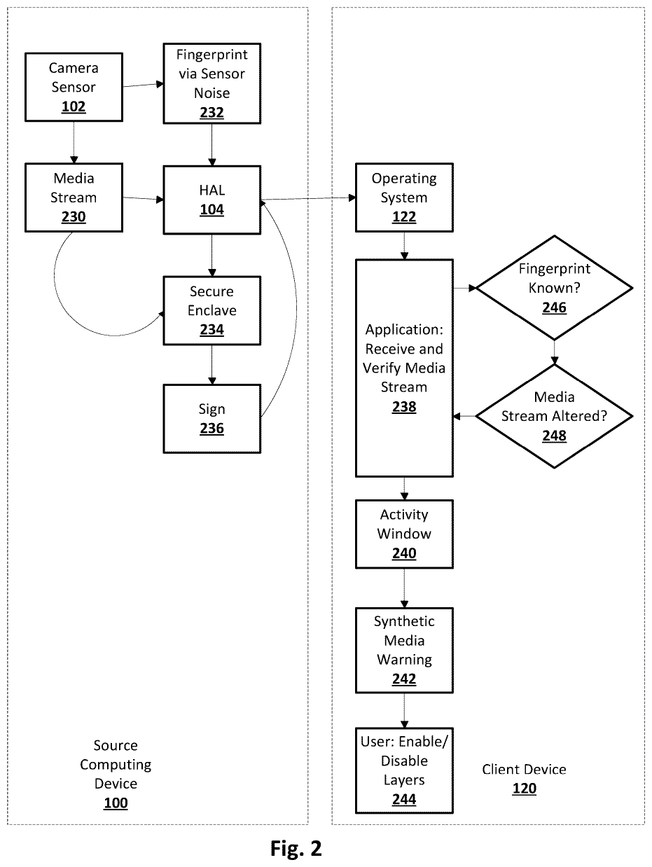

FIG. 2 depicts one example of how techniques described herein may be used to detect a deepfake in video digital content. The example shows the processes which might occur within the source computing device 100 and the client device 120 to detect a deepfake. The example begins with the camera sensor 102 which may capture digital content in the form of a media stream 230. In some implementations, the digital content may include multiple layers, such as video and audio layer(s), as well as one or more layers that include software-introduced alterations, such as a blurred background, one or more filters that alter an appearance and/or sound of people depicted in the video, etc. In various implementations, the source computing device 100 that creates the digital content, e.g., by capturing audio and/or visual data using one or more sensors, may bond, merge, interleave, or otherwise combine various layers together, e.g., into a single inseparable layer.

As a result of defects in the camera sensor 102, which can result from manufacturing defects (described above) or post-manufacturing defects (which may result from use of the source computing device 100 which houses the camera sensor 102), sensor noise may be recorded in addition to the video media stream 230. The relative uniqueness of the recorded sensor noise may be used to create a fingerprint 232 for the sensor that is relatively unique.

In some implementations, the video media stream 230 may also be passed to a secure enclave 234 where it can be signed 236, e.g., using a trusted platform module (TPM), trusted execution environment (TEE), secure environment/enclave (SE), or the like. Signing 236 of the media stream 230 may incorporate security token(s) into one or more of layers of the media stream 230. The secure enclave 234 is a gated hardware component meaning that while alterations made after the media stream 230 has been signed 236 by the secure enclave 234 are possible, they will be detectable. In the present example, once the secure enclave 234 has signed 236 the media stream 230 the signed media stream may be sent back to the HAL 208. Both the signed video media stream 230 and the sensor fingerprint 232 may then be combined into a single digital content in the HAL/VM 104.

The digital content may then be sent to the operating system 122 of the client device 120. The operating system 122 of the client device 120 may authenticate the security token(s) and/or signature, e.g., by using a key derivative function (KDF) to determine that their own TPM/SE has the same root or intermediate certification chain (or another trusted certificate or key). The operating system 122 may provide the digital content to an application 238. The application 238 may be responsible for receiving and verifying the authenticity of the media stream 230. Such an application may be a wide range of applications including, but not limited to, a video call application, a social media application, a stand-alone verification application, etc.

To verify the media stream 230, the application 238 may extract the sensor fingerprint 232 and the signature 236 from the media stream 230. At block 246, the application 238 may utilize the sensor fingerprint 232 to determine if the fingerprint is associated a known source computing device/sensor. Further, the application 238 may utilize the extracted signature 236 to detect alterations to the media stream at block 248.

The activity window 240 may be used to display a graphical user interface (GUI) of the application 238 to the user. In various implementations, the GUI may display a synthetic media warning 242 if the application 238 determines that either the fingerprint was unknown or the media stream was altered. A synthetic media warning 242 is indicative that the application 238 has determined an inconsistency within the received media stream 230 which may indicate that the media stream is at least partially synthetic, e.g., a deepfake, or that the user should be cautious concerning its contents.

In some implementations, the application 238 may then further allow the user to enable or disable layers 244 of the media stream. Such an ability may be useful if one layer of the media stream is determined to be altered while others are not. This would allow a user to view only the authenticated layers of the media stream while avoiding those determined to be altered. For example, when creating a video stream, a user may wish to blur their background for a variety of reasons, such as preserving their privacy, not disclosing their location, etc. This synthetic blurring may be represented as a layer of media stream 230, and may be signed by HAL (or a virtual machine) and/or by secure enclave 234. By contrast, other software manipulation of the media stream, such as another layer that alters the creator's appearance and/or sound, may be stored in a separate layer that is not attested by HAL 104 and/or secure enclave 234. This may allow the receiving user at block 244 to disable the unattested layer(s), so that the creator's original appearance is restored, whereas the receiving user may not have the ability to remove background blurring.

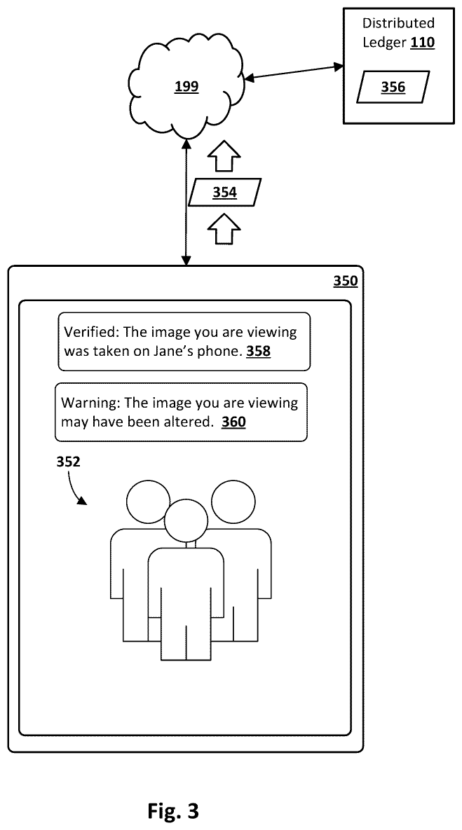

FIG. 3 depicts an example of a possible user experience when the above described techniques are implemented. The figure depicts a smartphone 350 running one or more processors capable of analyzing digital content such as the photo 352 shown in the smartphone 350 touch screen. In this example it can be assumed that the photo 352 was received from a source computing device (not depicted in FIG. 3), and that smartphone 350 will practice selected aspects of the present disclosure to determine whether the photo 352 comes from its purported source and/or whether the photo includes software-induced alteration(s).

In the present example, the smartphone's 350 processor(s) may extract a sensor fingerprint 354 from the photo 352. The extracted sensor fingerprint 354 may represent one or more noisy characteristics observed in the photo 352 that may have been introduced by the source computing device and/or camera that generated the photo 352. These noisy characteristics may include, for instance, manufacturing flaw(s) that causes pixel(s) to generate/have anomalous data values, e.g., values that diverge from expected ranges (e.g., ranges of neighboring pixels). Additionally or alternatively, these flaws may be caused by use after manufacturing such as scratches to the lens due to regular use of the device that houses the camera or cracks to the lens due to dropping the device that houses the camera on a hard surface.

As shown in FIG. 3, the smartphone's 350 processor(s) have compared the extracted sensor fingerprint 354 of the camera used to capture the photo 352 to a reference fingerprint 356 for the alleged source device that is stored in the distributed (and in many cases, immutable) ledger 110. Utilizing this comparison, the smartphone's 350 processor(s) have determined that the image was in fact generated by the camera on the source computing device associated with the reference sensor fingerprint 356. In some implementations, such as in this example, the smartphone 350 has consequently displayed a push notification 358 to the user to notify the user that the true source computing device of the photo 352 they are viewing has been verified as matching the purported source of the photo 352.

Additionally, the smartphone's 350 processor(s) may have identified one or more security tokens which were incorporated into the photo 352. For instance, the photo 352 may include multiple layers, such as foreground and background images, as well as one or more layers that include software-introduced alterations, such as a blurred background, one or more filters that alter an appearance of the people depicted in the photo 352, etc. In various implementations, the source computing device that created the photo may have bonded, merged, interleaved, or otherwise combine various layers together, e.g., into a single inseparable layer. The source computing device may have also incorporated security token(s) into one or more of the layers, e.g., via a VM and/or HAL.

The smartphone's 350 one or more processors may utilize the identified one or more security tokens which were incorporated into the photo 352 to determine if the photo 352 contains any software-introduced alterations. In some implementations, such as in this example, the smartphone 350 has displayed a push notification 360 to the user to notify the user that the image 352 they are viewing may include a software alteration.

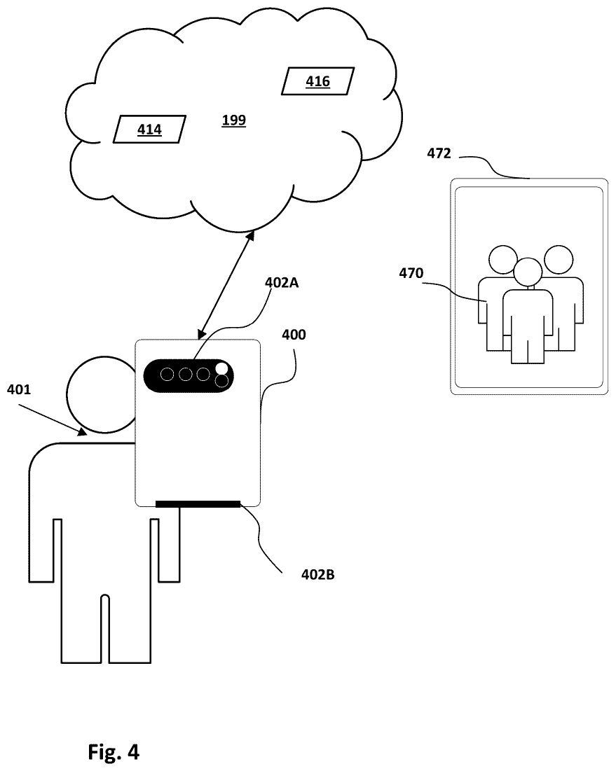

FIG. 4 depicts a smartphone 400 of a user 401 (Jane), capable of determining a sensor fingerprint of one or more sensors, in the present example both a camera 402A and a microphone 402B. In some implementations of the above-described techniques, as in this example, Jane's smartphone 400 may determine a sensor fingerprint for the one or more sensors. In the present case, the one or more processors of Jane's smartphone 400 have determined a fingerprint 414 for the camera 402A on Jane's smartphone 400. The one or more processors of Jane's smartphone 400 have also determined a fingerprint 416 for the microphone 402B on Jane's smartphone 400.

In the present example, the one or more processors of Jane's smartphone 400 have caused the sensor fingerprint for the camera 414 on Jane's smartphone 400 and the sensor fingerprint for microphone 416 on Jane's smartphone 400 to be stored in an immutable ledger (e.g., 112 in FIG. 1a). In some implementations, as in the current example, the immutable ledger (not depicted in FIG. 4) may be connected to device 400 via one or more networks 199 (which is why elements 414 and 416 are depicted in the cloud). These sensor fingerprints 414, 416 may represent one or more noisy characteristics of the camera 402A and/or microphone 402B such as a manufacturing flaw and/or flaws caused by use after manufacturing. These sensor fingerprints 414, 416 may be later utilized to determine whether subsequent digital content such as videos, audio, photos, or any combination thereof, was captured using the one or more the camera 402A on Jane's smartphone 400 or the microphone 402B on Jane's smartphone 400.

In some implementations, as in the present example, Jane's smartphone 400 may capture subsequent digital content such as a photo 470 or video using one or more of the camera 402A and/or the microphone 402B. Jane's smartphone 400 may then incorporate one or more security tokens into the photo 470. The photo 470 may include multiple layers, such as foreground and background images, as well as one or more layers that include software-introduced alterations, such as a blurred background, one or more filters that alter an appearance of people depicted in the photo 470, etc. In various implementations, the source computing device that created the photo, as in the present case, Jane's smartphone 400, may bond, merge, interleave, or otherwise combine various layers together, e.g., into a single inseparable layer. The source computing device, Jane's smartphone 400, may also incorporate security token(s) into one or more of the layers, e.g., via the VM/HAL 104. In some implementations, these incorporated security tokens may be utilized, e.g., by a receiving computing device 472, to determine if the digital content, in the present example, the photo 470, contains any software-introduced alterations.

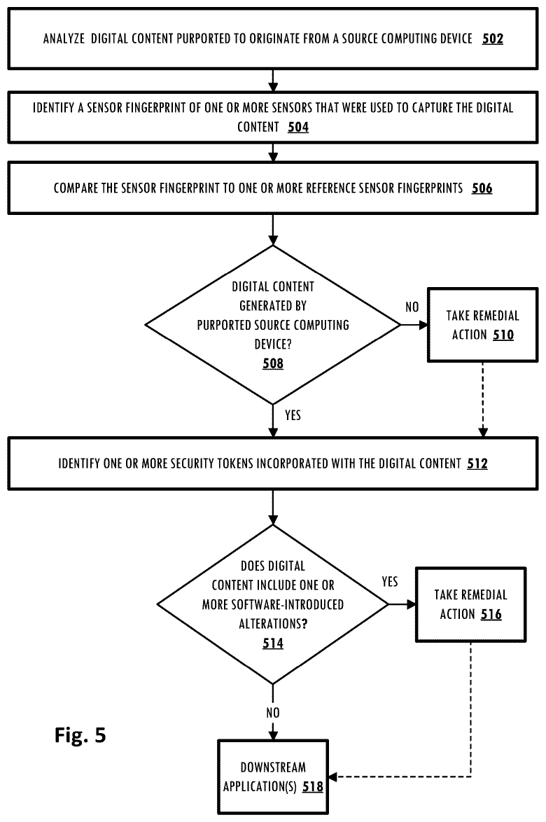

FIG. 5 depicts an example method 500 of practicing selected aspects of the present disclosure. For convenience, the operations of the flowchart are described with reference to a system that performs the operations. This system may include various components of various computer systems. Moreover, while operations of method 500 are shown in a particular order, this is not meant to be limiting. One or more operations may be reordered, omitted or added.

At block 502, the system may, e.g. by way of the operating system 122 of the client device 120, analyze digital content. Such digital content may be purported to have originated from a specific computing device, e.g. a source computing device 100. Through the analysis of block 502, at block 504, the system, e.g., by way of sensor fingerprint engine 124, may identify a sensor fingerprint of one or more sensors, e.g. sensor 102-1 . . . 120-N of the source computing device 100, that were used to capture the digital content. As an example, the one or more sensors could be a camera capable of capturing video content, a microphone capable of capturing audio content, etc.

At block 506, the system may compare the identified sensor fingerprint with one or more other reference sensor fingerprints. Such reference fingerprints may, for example, be stored locally on receiving computing devices (e.g., during a previous synchronous and trusted communication session), and/or may be stored as part of an immutable ledger 112 that is accessible by other computing devices to authenticate the source computing device subsequently. The other computing devices may then be able to compare sensor fingerprints extracted from subsequent digital content purported to be shared by the source computing device to the previously shared sensor fingerprint, e.g., to verify or refute the source. In some implementations, sensor fingerprints may be accessible via means other than or in addition to an immutable ledger. For example, individual contacts of a user's contact list may be associated with reference sensor fingerprints extracted from digital content provided by the respective contacts.

Utilizing such a comparison, at block 508, the system may determine whether the digital content was generated by the purported source computing device, e.g. source computing device 100, or not. If the answer is no, then method 500 may proceed to block 510. At block 510, various remedial actions may be triggered. For example, the system may notify the user that the digital content is deemed not to have originated from the purported source computing device, e.g., along with or as a warning. Additionally or alternatively, in some implementations, the system may prevent the digital content from being used for some downstream application or purpose, such as being used as a biometric signal to gain access to a resource protected using biometric security measures.

As indicated by the dashed line from block 510, in some but not all embodiments, 500 may continue to block 512. Additionally, if the answer at block 508 is no, then method 500 may also proceed to block 512. At block 512, the system may identify one or more security tokens incorporated within the digital content. In some implementations, these security tokens may be selectively incorporated into layer(s) so that those layer(s) become immutable, e.g., at a receiving device. By contrast, other layer(s) may remain mutable (e.g., capable of being disabled). For example, in some implementations, a source computing device may bond audio and video layers together into a combined immutable layer. The source device's HAL may then incorporate security token(s) into that immutable layer to indicate that the immutable layer's contents have not been altered downstream of the HAL, e.g., by a client application operating in user space of the source computing device. Meanwhile, other layers that were altered downstream of the HAL, such as layers that include filters altering an appearance of someone depicted in a video, may not include security tokens and therefore may be identifiable as including software-introduced alteration(s).

At block 514, the system may use the identified security token to determine whether the digital content includes one or more software-introduced alterations 512. If the answer is yes, then method 500 may proceed to block 516, at which point one or more remedial actions may be triggered. These remedial actions may include, for instance, notifying the user (e.g., via a push notification) that the digital content may be a deepfake, classifying the digital content as a deepfake, preventing the classified deepfake from being propagated to or used by any downstream applications, providing the user with an opportunity to disable one or more of the alterations if possible, etc.

As indicated by the dashed line from block 516, in some (but not all) implementations, method 500 may proceed from block 516 to block 518. For example, the user may wish to proceed with interacting with (e.g., consuming) the digital content in spite of the fact that it has been altered by software. Alternatively, if the answer at block 514 is no, then method 500 may proceed to block 518. Whichever the case, at block 518, the system may provide the digital content to one or more downstream applications. For example, if the digital content is to be used for biometric authentication and it was determined not to be a deepfake, then the digital content may be submitted for biometric authentication.

Method 500 includes operations for both identifying and comparing sensor fingerprints to verify or refute a purported source of digital content, and for evaluating security token(s) to determine whether the digital content has been altered using software. However, it is not required that both checks be performed, and in fact these checks may be performed independently of each other. For example, an extracted sensor fingerprint may be used to verify or refuse a purported source of digital content, without evaluating the digital content for security tokens. Likewise, the digital content may be evaluated for security tokens without attempting to verify or refute the purported source of the digital content.

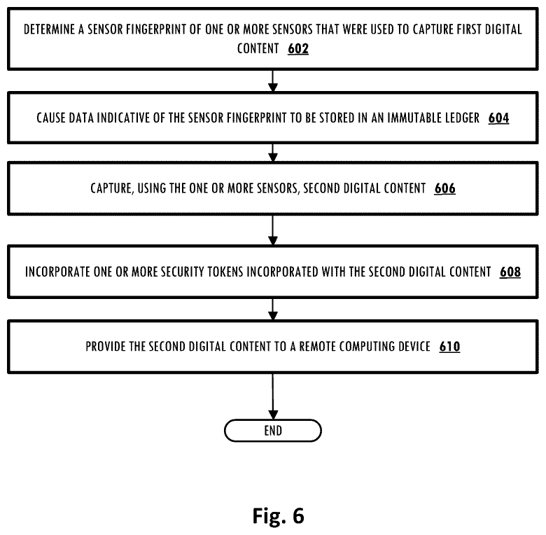

FIG. 6 depicts an example method 600 of practicing selected aspects of the present disclosure. For convenience, the operations of the flowchart are described with reference to a system that performs the operations. This system may include various components of various computer systems, such as source computing device 100. Moreover, while operations of method 600 are shown in a particular order, this is not meant to be limiting. One or more operations may be reordered, omitted or added.

At block 602, the system may extract or otherwise determine a sensor fingerprint of one or more sensors e.g. sensor 102-1 . . . 120-N of the source computing device 100, that were used to capture first digital content. As an example, the one or more sensors could be a camera capable of capturing video content, a microphone capable of capturing audio content, etc. The determined sensor fingerprint may represent one or more noisy characteristics of the one or more sensors.

At block 604, the system may then cause data indicative of the sensor fingerprint to be stored in an immutable ledger (e.g., 112). Such an immutable ledger may be accessible by other computing devices to authenticate the source computing device subsequently. The other computing devices may then be able to compare sensor fingerprints extracted from subsequent digital content purported to be shared by the source computing device to the previously shared sensor fingerprint, e.g., to verify or refute the source.

At block 606, the system may capture, using the same one or more sensors, second digital content. At block 608, the system may incorporate one or more security tokens into the second digital content 608, e.g. via the VM and/or HAL 104 of the source computing device 100. Security token(s) may be incorporated into one or more immutable layers to indicate that the immutable layers' contents have not been altered downstream of the VM/HAL 104, e.g., by a client application operating in user space of the source computing device. Meanwhile, other layers that were altered downstream of the VM/HAL 104, such as layers that include filters altering an appearance of someone depicted in a video, may not include security tokens and therefore may be identifiable as including software-introduced alteration(s). At block 610, the system may provide the second digital content to a remote computing device.

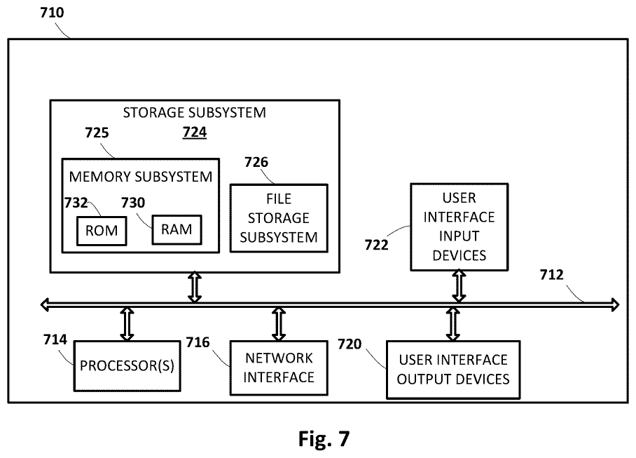

FIG. 7 is a block diagram of an example computer system 710. Computer system 710 typically includes at least one processor 714 which communicates with a number of peripheral devices via bus subsystem 712. These peripheral devices may include a storage subsystem 724, including, for example, a memory subsystem 725 and a file storage subsystem 726, user interface output devices 720, user interface input devices 722, and a network interface subsystem 716. The input and output devices allow user interaction with computer system 710. Network interface subsystem 716 provides an interface to outside networks and is coupled to corresponding interface devices in other computer systems.

User interface input devices 722 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computer system 710 or onto a communication network.

User interface output devices 720 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 710 to the user or to another machine or computer system.

Storage subsystem 724 stores programming and data constructs that provide the functionality of some or all of the modules described herein. For example, the storage subsystem 724 may include the logic to perform selected aspects of method 500 and/or 600. Memory 725 used in the storage subsystem 724 can include a number of memories including a main random-access memory (RAM) 730 for storage of instructions and data during program execution and a read only memory (ROM) 732 in which fixed instructions are stored. A file storage subsystem 726 can provide persistent storage for program and data files, and may include a hard disk drive, a CD-ROM drive, an optical drive, or removable media cartridges. Modules implementing the functionality of certain implementations may be stored by file storage subsystem 726 in the storage subsystem 724, or in other machines accessible by the processor(s) 714.

Bus subsystem 712 provides a mechanism for letting the various components and subsystems of computer system 710 communicate with each other as intended. Although bus subsystem 712 is shown schematically as a single bus, alternative implementations of the bus subsystem may use multiple buses.

Computer system 710 can be of varying types including a workstation, server, computing cluster, blade server, server farm, smart phone, smart watch, smart glasses, set top box, tablet computer, laptop, or any other data processing system or computing device. Due to the ever-changing nature of computers and networks, the description of computer system 710 depicted in FIG. 7 is intended only as a specific example for purposes of illustrating some implementations. Many other configurations of computer system 710 are possible having more or fewer components than the computer system depicted in FIG. 7.

In some implementations, a computer implemented method may be provided that includes: analyzing digital content purported to originate from a source computing device to identify a sensor fingerprint of one or more sensors that were used to capture the digital content, wherein the sensor fingerprint represents one or more noisy characteristics of the one or more sensors; comparing the sensor fingerprint to one or more reference sensor fingerprints; based on the comparing, making a first determination of whether the digital content was generated by the source computing device; identifying one or more security tokens incorporated with the digital content; and based on one or more of the security tokens, making a second determination of whether the digital content includes one or more software-introduced alterations.

In various implementations, the security tokens may have been incorporated into the digital content via a hardware abstraction layer (HAL). In various implementations, the security tokens may have been incorporated into the digital content via a virtual machine (VM).

In various implementations, the one or more sensors that were used to capture the digital content may include one or more digital cameras. In various implementations, the digital content may include one or more digital image frames. In various implementations, the one or more digital image frames may form a digital video. In various implementations, the digital content may take the form of a live digital video stream. In various implementations, the sensor fingerprint may identify one or more pixels of one or more of the digital cameras that generate anomalous data. In various implementations, the anomalous data may include one or more pixel values that are outside of one or more expected ranges.

In various implementations, the method may include causing output to be rendered at one or more output devices, wherein the output conveys one or more results of one or more of the first or second determinations. In various implementations, the second determination may include a determination that the digital content includes one or more alterations introduced by a computer application operating in user space of the source computing device.

In various implementations, the method may further include: causing one or more selectable elements to be rendered at one or more output devices, wherein the one or more selectable elements are operable to disable one or more of the software-introduced alterations during rendition of the digital content; determining that one or more of the selectable elements were operated; and in response to determining that one or more of the selectable elements were operated, disabling one or more of the software-introduced alterations during rendition of the digital content. In various implementations, the digital content may include one or more digital image frames, and one or more of the software-introduced alterations comprises a digital filter applied to one or more of the digital image frames.

In various implementations, the method may include retrieving one or more of the reference sensor fingerprints from an immutable ledger. In various implementations, the method may include retrieving one or more of the reference sensor fingerprints from a contact of a contact list. In various implementations, the one or more security tokens may be incorporated into a combined immutable layer of the digital content. In various implementations, the combined immutable layer may include a video layer of the digital content and an audio layer of the digital content. In various implementations, the combined immutable layer further includes a blurred background filter. In various implementations, the digital content may include a mutable layer. In various implementations, the mutable layer may include one or more software-introduced alterations to the digital content.

In another aspect, a method may be implemented using one or more processors and may include: determining a sensor fingerprint of one or more sensors that were used to capture first digital content, wherein the sensor fingerprint represents one or more noisy characteristics of the one or more sensors; causing data indicative of the sensor fingerprint to be stored in an immutable ledger, wherein the sensor fingerprint is operable to determine whether subsequent digital content was captured using the one or more sensors; subsequent to the causing, capturing, using the one or more sensors, second digital content; incorporating one or more security tokens incorporated with the second digital content, wherein the one or more security tokens are operable to determine whether the second digital content includes one or more software-introduced alterations; and providing the second digital content to a remote computing device.

In various implementations, the one or more security tokens are incorporated into a combined immutable layer of the second digital content. In various implementations, the combined immutable layer may include a video layer of the second digital content and an audio layer of the second digital content. In various implementations, the combined immutable layer further includes a blurred background filter. In various implementations, the second digital content may include a mutable layer. In various implementations, the mutable layer may include one or more software-introduced alterations to the second digital content.

Other implementations may include a non-transitory computer readable storage medium storing instructions executable by a processor to perform a method such as one or more of the methods described above. Yet another implementation may include a control system including memory and one or more processors operable to execute instructions, stored in the memory, to implement one or more modules or engines that, alone or collectively, perform a method such as one or more of the methods described above.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure

What is claimed is:

1. A method implemented using one or more processors, comprising:
analyzing digital content purported to originate from a source computing device to identify a sensor fingerprint of one or more sensors that were used to capture the digital content, wherein the sensor fingerprint represents one or more noisy characteristics of the one or more sensors;
comparing the sensor fingerprint to one or more reference sensor fingerprints;
based on the comparing, making a first determination of whether the digital content was generated by the source computing device;
identifying one or more security tokens incorporated with the digital content; and
based on one or more of the security tokens, making a second determination of whether the digital content includes one or more software-introduced alterations.

2. The method of claim 1, wherein the security tokens were incorporated into the digital content via a hardware abstraction layer (HAL) or via a virtual machine (VM).

3. The method of claim 1, wherein the one or more sensors that were used to capture the digital content comprise one or more digital cameras.

4. The method of claim 3, wherein the digital content comprises one or more digital image frames of a digital video.

5. The method of claim 3, wherein the digital content comprises a live digital video stream.

6. The method of claim 3, wherein the sensor fingerprint identifies one or more pixels of one or more of the digital cameras that generate anomalous data, wherein the anomalous data comprises one or more pixel values that are outside of one or more expected ranges.

7. The method of claim 1, further comprising causing output to be rendered at one or more output devices, wherein the output conveys one or more results of one or more of the first or second determinations.

8. The method of claim 1, wherein the second determination comprises a determination that the digital content includes one or more alterations introduced by a computer application operating in user space of the source computing device.

9. The method of claim 1, further comprising:
causing one or more selectable elements to be rendered at one or more output devices, wherein the one or more selectable elements are operable to disable one or more of the software-introduced alterations during rendition of the digital content;
determining that one or more of the selectable elements were operated; and
in response to determining that one or more of the selectable elements were operated, disabling one or more of the software-introduced alterations during rendition of the digital content.

10. The method of claim 9, wherein the digital content comprises one or more digital image frames, and one or more of the software-introduced alterations comprises a digital filter applied to one or more of the digital image frames.

11. The method of claim 1, further comprising retrieving one or more of the reference sensor fingerprints from an immutable ledger or from a contact of a contact list.

12. The method of claim 1, wherein the one or more security tokens are incorporated into a combined immutable layer of the digital content.

13. The method of claim 12, wherein the combined immutable layer comprises a video layer of the digital content and an audio layer of the digital content.

14. The method of claim 13, wherein the combined immutable layer further comprises a blurred background filter.

15. The method of claim 14, wherein the digital content further comprises a mutable layer.

16. The method of claim 15, wherein the mutable layer comprises one or more software-introduced alterations to the digital content.

17. A method implemented using one or more processors, comprising:
determining a sensor fingerprint of one or more sensors that were used to capture first digital content, wherein the sensor fingerprint represents one or more noisy characteristics of the one or more sensors;
causing data indicative of the sensor fingerprint to be stored in an immutable ledger, wherein the sensor fingerprint is operable to determine whether subsequent digital content was captured using the one or more sensors;
subsequent to the causing, capturing, using the one or more sensors, second digital content;
incorporating one or more security tokens incorporated with the second digital content, wherein the one or more security tokens are operable to determine whether the second digital content includes one or more software-introduced alterations; and
providing the second digital content to a remote computing device.

18. The method of claim 17, wherein the one or more security tokens are incorporated into a combined immutable layer of the second digital content, wherein the combined immutable layer comprises a video layer of the second digital content and an audio layer of the second digital content.

19. The method of claim 18, wherein the combined immutable layer further comprises a blurred background filter.

20. A method implemented using one or more processors, comprising:
analyzing digital content purported to originate from a source computing device to identify a sensor fingerprint of one or more sensors that were used to capture the digital content, wherein the sensor fingerprint represents one or more noisy characteristics of the one or more sensors;
comparing the sensor fingerprint to one or more reference sensor fingerprints;
based on the comparing, making a determination of whether the digital content was generated by the source computing device; and
triggering one or more remedial actions based on the determination.
